(19) United States
(12) Patent Application Publication
(10) Pub. No.: US 2016/0006359 A1
(43) Pub. Date: Jan. 7, 2016

(54) DC-DC CONVERTER WITH A PROTECTION STAGE

(71) Applicant: TDK-LAMBDA LTD, Karmiel (IL)

(72) Inventors: Ami Pelzman, Nahariya (IL); Ilia Podlisk, Karmiel (IL)

(21) Appl. No.: 14/790,836

(22) Filed: Jul. 2, 2015

(30) Foreign Application Priority Data
Jul. 3, 2014 (IL) 233513

(51) Int. Cl. H02M 3/335

(52) U.S. Cl. CPC H02M 3/33507

(57) ABSTRACT

The invention relates to a DC to DC converter which comprises: (a) regulation stage for receiving a non-regulated DC voltage and for producing a regulated DC voltage; (b) a switching stage for converting said regulated DC voltage to a substantially AC Voltage signal; (e) an isolation stage for receiving said AC Voltage signal, and for producing a regulated output DC voltage having a voltage level which differs from a voltage level of said regulated DC voltage, and for isolating said regulated output DC voltage from said regulation stage; and (d) a control component for providing a feedback from said isolation to said regulation stage; wherein said DC to DC converter comprises at the regulation stage a protection unit which in turn comprises a capacitor in series with a parallel circuit which in turn comprises: a switching element in parallel with a resistor, inductor, or a controlled current limiting element.

### CROSS REFERENCE TO RELATED APPLICATIONS

This application claims priority to Israel Application No. 233513, filed on Jul. 3, 2014, which is incorporated by reference in its entirety.

### BACKGROUND

DC to DC converters are widely used within switching type power supplies. A DC to DC converter typically receives unregulated DC input, and provides at its output a regulated DC voltage. Generally the DC output voltage level is different than the DC input voltage level.

A typical structure of a voltage fed type of DC to DC converter is shown in FIG. 1a. The converter generally comprises a regulation stage 101 and an isolation stage 102. Regulation stage 101 converts the input unregulated DC voltage to a regulated DC output voltage. The purpose of the isolation stage 102 is to change the regulated voltage from the regulation stage 101 to another DC level and to isolate the output voltage Vₒᵤₜ from input.

A feedback control unit 116 receives a sample of the output voltage from the isolation stage 102, and controls the switching periods of a switching control transistor 130 (in this typical case, MOSFET) at the regulation stage 101. In fact, the control unit 116 receives the DC level of capacitor 140 (or a sample thereof), and based on this level it varies the Duty Cycle (Pulse Width Modulation—PWM) which is provided to control transistor 130. In such a manner control transistor 130 controls the output voltage level from the regulated stage (on capacitor 104) which is in fact the DC level to the input section 200 which comprises 4 switching MOSFETs.

As noted, as a result of the operation of the control transistor 130, an unregulated charge which is proportional to said Duty Cycle (PWM signal), is accumulated at capacitor 104 (hereinafter, capacitor 104 will be referred to as “energy accumulating capacitor”, or briefly “accumulating capacitor”). The switching section 200, which typically comprises four MOSFETs, transforms the DC voltage on capacitor 104 into a square 50% modulated signal which is fed into the primary coil of transformer 123. The signal at the secondary coil of transformer 123 is rectified by rectifier 124 (which in this example comprises 4 diodes), and stabilized by capacitor 140.

The DC to DC converter of FIG. 1a which, among other components, comprises capacitor 104 is generally referred to as a voltage fed topology. A converter which does not include the capacitor 104 at the regulation stage, i.e., in the form as seen in FIG. 1b, is typically referred to as a current fed topology. In the current fed topology, even though there is no physical capacitor at the regulation stage (i.e., capacitor 104 which appears at the voltage fed topology of FIG. 1a), a virtual capacitor in fact exists at the location of capacitor 104 due to reflection of capacitor 140 from the isolation stage to the regulation stage via transformer 123.

In the voltage fed topology of the DC to DC converter which has been discussed above, energy which is first accumulated within capacitor 104 is transferred from the regulation stage to the isolation stage by means of the 50% square signal formed by the switching transistors 121. More specifically, the switching transistors, when activated, cause a discharge of capacitor 104, and the energy as accumulated within the capacitor is transferred via the transformer 123 to the rectifier 124.

The current fed circuit is characterized by a relatively small current spike through the switching transistors (stage 200), however it is disadvantageous as it causes a relatively high voltage spike on each of the switching transistors. These spikes are due to parasitic capacitors that exist in the 4 MOSFETs 121. On the other hand, a voltage fed topology is characterized by a relatively large current spike at each of the switching transistors (stage 200), but with a relatively small voltage spike on each of said transistors.

It has been found by the inventors that the current and voltage spikes that are formed during said switching within the switching stage 200, cause a reduction of efficiency and an increase of the electromagnetic noise from the device.

It is an object of the present invention to improve the efficiency of a DC to DC converter, by eliminating the excessive losses caused by said current or voltage spikes within the switching transistors.

It Is another object of the present invention to reduce the noise level which is cause by the DC to DC converter.

Other objects and advantages of the invention will become apparent as the description proceeds.

### SUMMARY OF THE INVENTION

A DC to DC converter which comprises: (a) regulation stage for receiving a non-regulated DC voltage and for producing a regulated DC voltage; (b) a switching stage for converting said regulated DC voltage to a substantially AC Voltage signal; (c) an isolation stage for receiving said AC Voltage signal, and for producing a regulated output DC voltage having a voltage level which differs from a voltage level of said regulated DC voltage, and for isolating said regulated output DC voltage from said regulation stage; and (d) a control component for providing a feedback from said isolation to said regulation stage; wherein said DC to DC converter comprises at the regulation stage a protection unit which in turn comprises a capacitor in series with a parallel circuit which in turn comprises: a switching element in parallel with a resistor, inductor, or a controlled current limiting element.

Preferably, said switching element is a controlled or uncontrolled element, selected from a group comprising a diode or a transistor.

Preferably, spikes due to abrupt excess of voltage at said regulation stage are eliminated by maneuvering excess of charge into said accumulating capacitor, and wherein spikes due to abrupt excess of current consumption from said accumulating capacitor are eliminated by said inductor, resistor, or current limiting element.

The invention also relates to a method for protecting a DC to DC converter which is characterized by the providing a protection unit at regulation and switching stages within said converter, said protection unit receives transient spikes energy that exist at a regulated DC voltage, converts said energy, and sends this converted energy during a steady state to a switching stage.

Preferably, said transfer of energy from the regulation stage to the switching stage is carried out in a current fed mode.

Preferably, said protection unit accumulates energy from said transient spikes at a voltage fed mode, while said accumulated energy is transferred to the switching stage in a current fed mode.

Preferably, said protection unit is located between said regulation stage and said switching stage.

Preferably, said protection unit is connected in parallel between said regulation stage and said switching stage.

Preferably, said protection unit comprises one or more switching elements and one or more accumulating elements.

Preferably, said accumulating element is a capacitor.

Preferably, said switching element determines a time of accumulating and a time of transfer of said energy.

Preferably, said switching element is bidirectional.

Preferably, said bidirectional switching element is an uncontrolled element or a controlled element.

Preferably, the uncontrolled element is a diode and said controlled element is a transistor.

### BRIEF DESCRIPTION OF THE DRAWINGS

FIG. 1a shows a typical prior art structure of a voltage fed type DC to DC converter;

FIG. 1b shows a typical prior art structure of a current fed type DC to DC converter;

FIG. 2a shows relevant steady state signals in the prior art voltage fed DC to DC converter of FIG. 1a;

FIG. 2b shows the relevant steady state signals in the prior art current fed DC to DC converter of FIG. 1b;

FIG. 2c shows signals during a transient situation of the current fed circuit of FIG. 1b;

FIG. 3a shows a DC to DC converter according to a first embodiment of the present invention;

FIG. 3b shows a DC to DC converter according to a second embodiment of the present invention;

FIG. 3c shows a DC to DC converter according to a third embodiment of the present invention;

FIG. 3d shows a DC to DC converter according to a fourth embodiment of the present invention;

FIG. 4a shows steady state current and voltage signals that are typical to the embodiments of FIGS. 3a-3c of the present invention; and

FIG. 4b shows current and voltage signals that are typical to the embodiments of FIGS. 3a-3c of the present invention in case of a transient situation.

### DETAILED DESCRIPTION OF PREFERRED EMBODIMENTS OF THE INVENTION

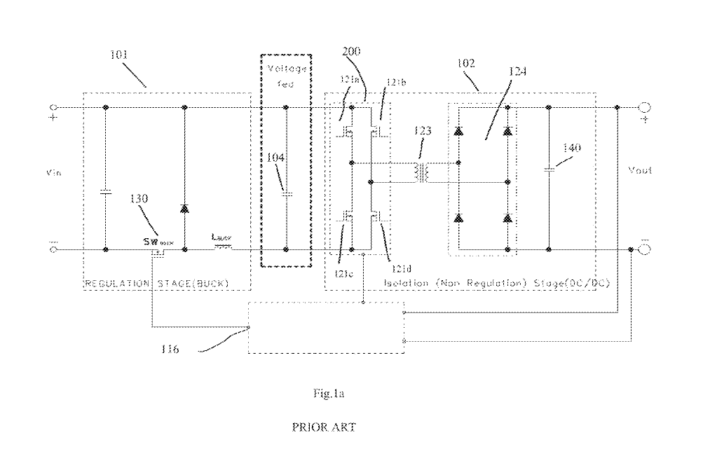

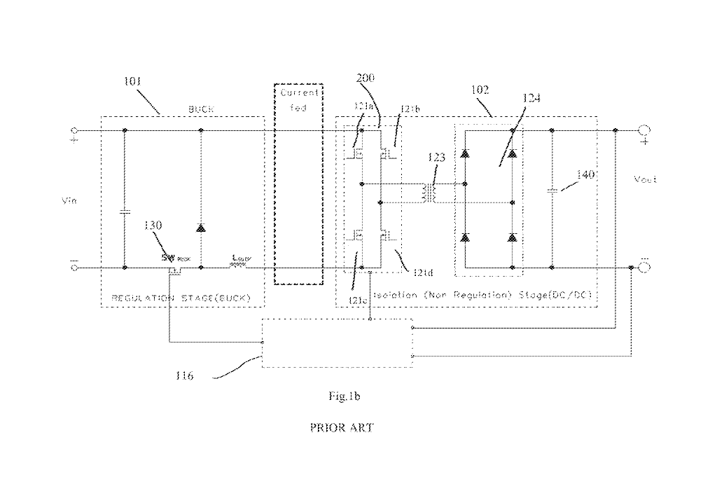

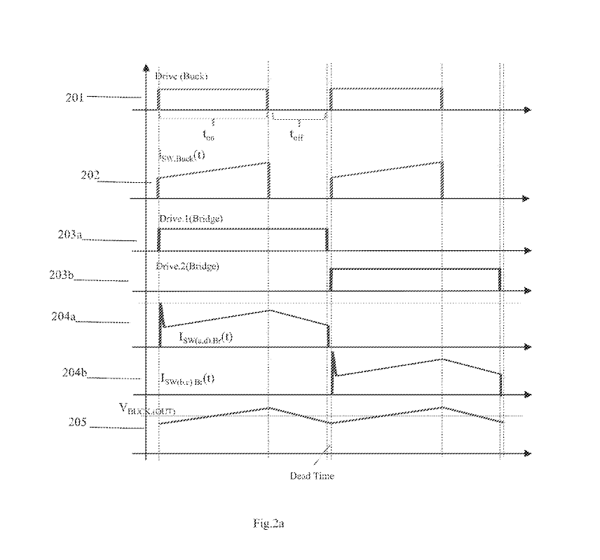

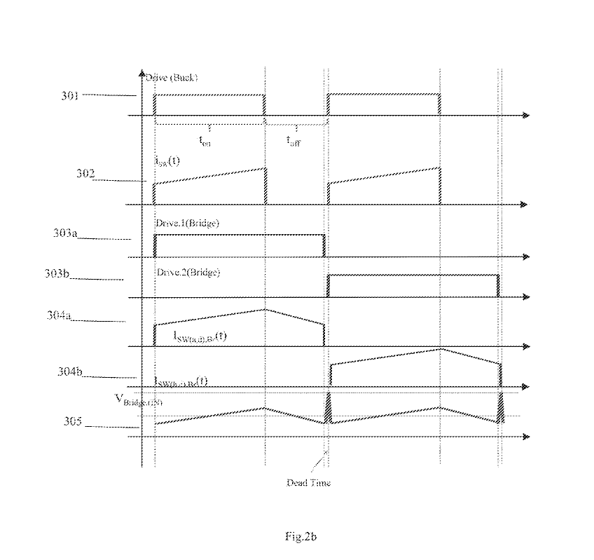

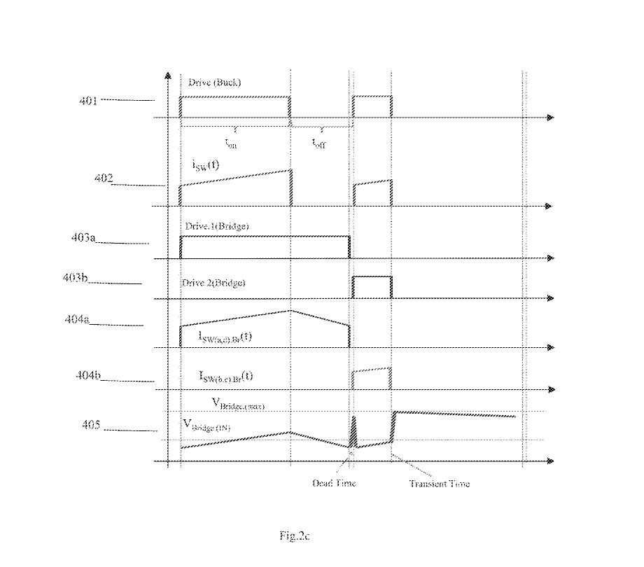

FIG. 2a shows relevant steady state signals in the prior art voltage fed DC to DC converter of FIG. 1a, FIG. 2b shows the relevant steady state signals in the prior art current fed DC to DC converter of FIG. 1b. FIG. 2c shows signals during a transient situation of the current fed circuit of FIG. 1b. Signals 201, 301 and 401 respectively represent the voltage at the gate of control transistor 130. More specifically, this signal shows the PWM (Pulse width modulation) signal discussed above. Signals 202, 302. and 402 respectively show the current flow through the control transistor 130. Signals 203a, 303a and 403a respectively show a gate voltage over a first pair of the switching transistors 121 (for example, transistors 121a and 121d), and signals 203b, 303b and 403b respectively show a gate voltage over a second pair of transistors 121 (for example, transistors 121b and 121c). Signals 204a, 204b, 304a, 304b, 404a, and 404b respectively show the current through each of said switching transistors 121, and signals 205, 305 and 405 respectively show the voltage over the output of the regulation stage 101.

As shown, current spikes appear within the current signals 204a and 204b of the voltage fed circuit of FIG. 1a. Voltage spikes appear within the voltage signals 305 and 405 of the current fed circuit of FIG. 1b. The spikes in signals 204a, 204b, 305 and 405 occur each time when a pair of transistors 121 is activated. As noted above, these spikes cause reduction of the efficiency of the converter.

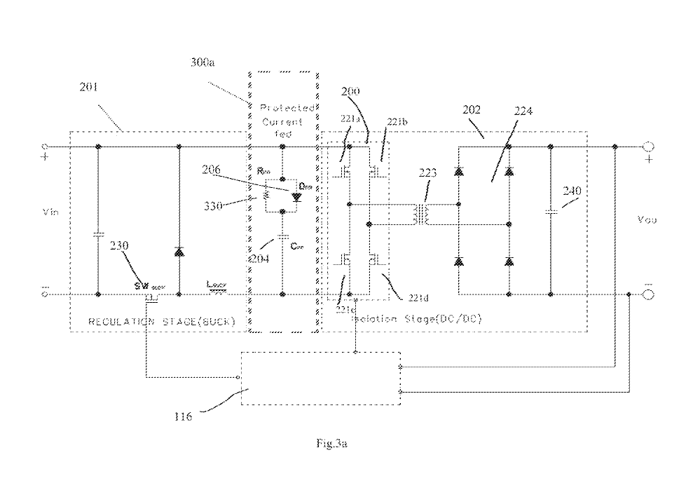

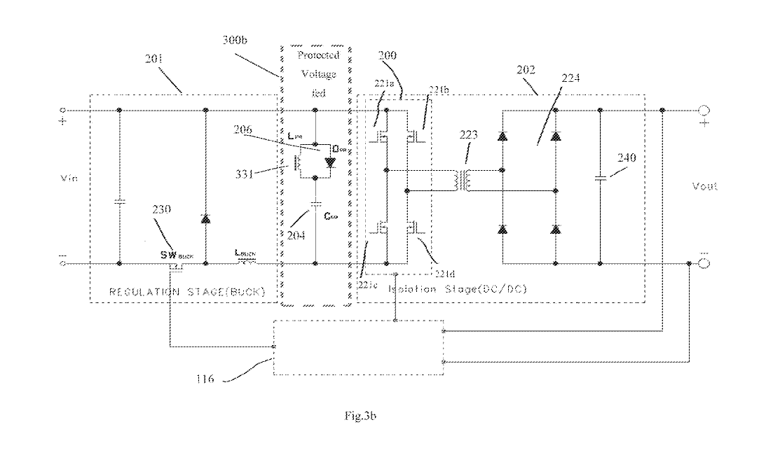

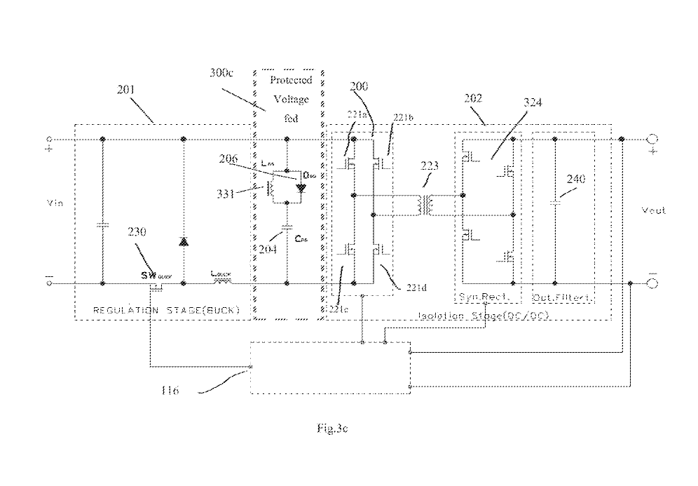

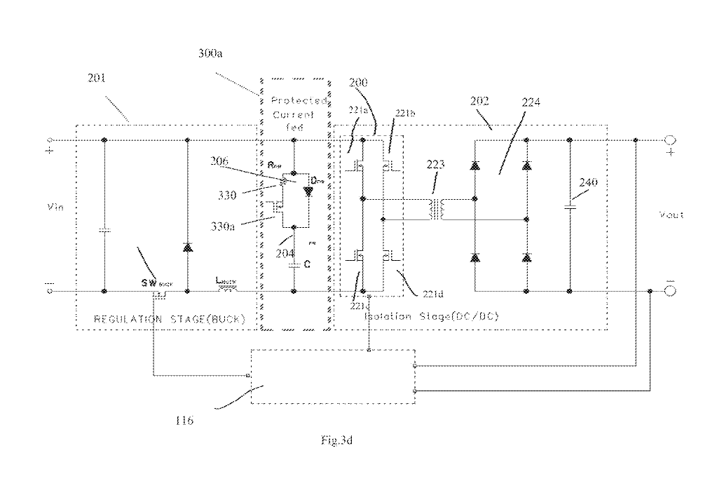

FIG. 3a shows a DC to DC converter according to first embodiment of the present invention. FIG. 3b shows a DC to DC converter according to a second embodiment of the invention. FIG. 3c shows a DC to DC converter according to a third embodiment of the present invention. As shown, a protection unit 300a is provided which includes a capacitor 204 in series with: a diode 206 in parallel to a resistor 330 (in FIGS. 3a and 3d), or alternatively, a diode 206 in parallel to an inductor 331 (in FIGS. 3b and 3c).

The DC to DC converter of the present invention operates as a combination of the voltage fed converter of FIG. 1a and of the current fed converter of FIG. 1b. Similar to the voltage fed converter of FIG. 1a which comprises an accumulating capacitor 104, the DC to DC converter of the present invention comprises an accumulating capacitor 204. The protection unit 300 operates during excess of voltage level at the output of the regulation stage 201. At this time the excess of voltage charges the capacitor 204 through diode 206, therefore the excess of voltage is fast eliminated. On the other hand, when an excess of current consumption occurs at the output of the isolation stage 202, which results in reduction of voltage level at the output of the regulation stage 201, the rate of discharge of capacitor 204 towards transistors 221 is limited by means of resistor 330 or inductor 331 respectively. In such a manner a protection is provided by the protection unit 300 of the present invention for two cases: (a) an excess of voltage at the output of the regulation stage 201 is eliminated; and (b) current spikes that are caused at times of excess of current consumption at the output of the isolation stage 202 are also eliminated.

FIG. 3d shows a DC to DC converter according to a fourth embodiment of the present invention. The embodiment of Fig, 3d is similar to the embodiment of FIG. 3a, however, with the addition of a control switch 330a in series with resistor 330. This embodiment enables a control over the timing of enabling the current to flow through resistor 330. Preferably, this switch is closed in some delay to obtain an effect somewhat similar to the effect of the circuits of FIGS. 3b and 3c, where an inductor is used (as is known, an inductor resists to a fast development of a current flow, and therefore the flow of current is delayed).

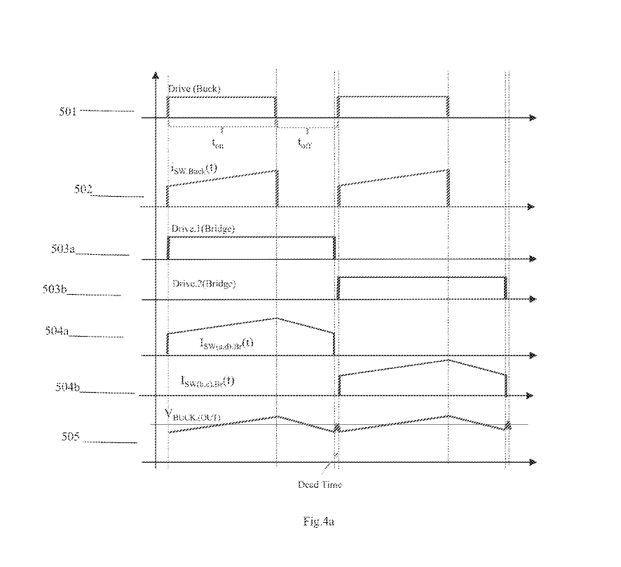

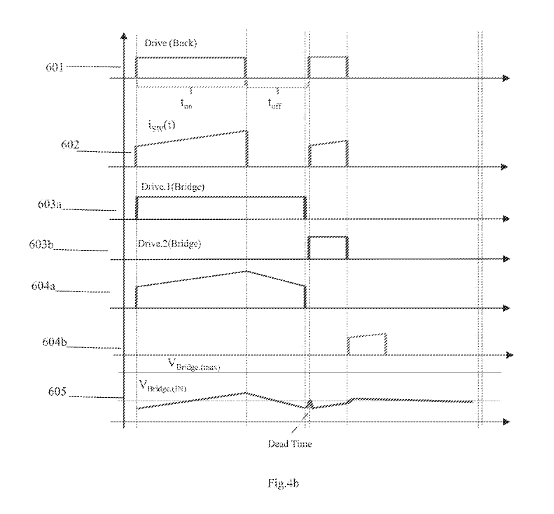

FIG. 4a shows steady state current and voltage signals within the DC to DC converters of the embodiments of FIGS. 3a-3c respectively. Signal 501 represents the voltage over the gate of control transistor 230. More specifically, this signal shows the PWM signal discussed above. Signal 502 shows the current flow through the control transistor 230. Signals 503a shows the voltage at the respective gates of a first pair from the four switching transistors 221 (for example, transistors 221a and 221d), and signal 503b shows the voltage at the respective gates of a second pair from the four transistors 221 (for example, transistors 221b and 221c)—this is in similarity to signals 203a, 203b, 303a, 303b, 403a and 403b of FIGS. 2a, 2b, and 2c respectively). Signals 504a and 504b show the current through each of said switching transistors 221. As can be seen from inspecting signals 504a, 504b and 505 of FIG. 4a, spikes that existed respectively in the signals 204a, 204b, 305 and 405 of the voltage fed and current fed topologies of FIGS. 2a, 2b and 2c are diminished in all the embodiments of the present invention.

4b shows current and voltage signals in the circuits of FIGS. 3a-3c in case of a transient situation. Signal 601 represents the voltage over the gate of control transistor 230. More specifically, this signal shows the PWM signal discussed above. Signal 602 shows the current flow through the control transistor 230. Signals 603a shows the voltage at the gates of a first pair from the four switching transistors 221 (for example, transistors 221a and 221d), and signal 603b shows the voltage at the respective gates of a second pair from the four transistors 221 (for example, transistors 221b and 221c)—this is in similarity to signals 203a, 203b, 303a, 303b, 403a and 403b of FIGS. 2a, 2b and 2c respectively. Signals 604a and 604b shows the current through each of said switching transistors 221. As shown in signals 604a, 604b and 605 of FIG. 4a, spikes that existed in the signals 204a, 204b, 305 and 405 of the voltage fed and current fed topologies of FIGS. 2a, 2b and 2c during transient situations have been diminished in the embodiments of the present invention.

The DC to DC converters of FIGS. 3a and 3b comprise a diode based rectifier at the isolation stage. The DC to DC converter of FIG. 3c, which comprises a synchronous rectifier 324 with four MOSFET transistors, has still an additional advantage compared to the diode based rectifier. More specifically, the structure of FIG. 3c enables a return of excessive energy from capacitor 240 which is located at a secondary portion of the converter, back to capacitor 204 which is located at a primary portion of the converter. This advantageous feature becomes possible in the circuit of FIG. 3c due to the fact that each MOSFFT in the synchronous rectifier 324 enables a bi-directional flow of current. In contrary, the diodes of FIGS. 3a and 3b enable only a unidirectional flow of current, therefore, such energy return which is characteristic to the circuit of FIG. 3c is impossible in the embodiments of FIGS. 3a and 3b. The returned energy of the embodiment of FIG. 3c is re-accumulated within capacitor 204. This is useful, for example, when there is no consumption from the output voltage Vₒᵤₜ. In that case, the invention according to the embodiment of FIG. 3c allows a discharge of the energy from the output capacitor 240 through the MOSFET to the secondary of the transformer 223, then to the primary of said transformer, and through diode 206 back to the capacitor 204. When such an energy return is required, the MOSFETs of the synchronous rectifier 324 are switched to an ON state to enable such an energy return from the isolation stage to the regulation stage of the converter.

While some embodiments of the invention have been described by way of illustration, it will be apparent that the invention can be carried out with many modifications variations and adaptations, and with the use of numerous equivalents or alternative solutions that are within the scope of persons skilled in the art, without departing from the spirit of the invention or exceeding the scope of the claims.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A DC to DC converter which comprises:
a. a regulation stage for receiving a non-regulated DC voltage and for producing a regulated DC voltage;
b. a switching stage for converting said regulated DC voltage to a substantially AC Voltage signal;
c. an isolation stage for receiving said AC Voltage signal, and for producing a regulated output DC voltage having a voltage level which differs from a voltage level of said regulated DC voltage, and for isolating said regulated output DC voltage from said regulation stage; and
d. a control component for providing a feedback from said isolation to said regulation stage;
wherein said DC to DC converter comprises at the regulation stage a protection unit which in turn comprises a capacitor in series with a parallel circuit which in turn comprises: a switching element in parallel with a resistor, inductor, or a controlled current limiting element.

2. A DC to DC converter according to claim 1 wherein said switching element is a controlled or uncontrolled element, selected from a group comprising a diode or a transistor.

3. A DC to DC converter according to claim 1, wherein spikes due to abrupt excess of voltage at said regulation stage are eliminated by maneuvering excess of charge into said accumulating capacitor, and wherein spikes due to abrupt excess of current consumption from said accumulating capacitor are eliminated by said inductor, resistor, or current limiting element.

4. A method for protecting a DC to DC converter, which is characterized by the providing a protection unit at regulation and switching stages within said converter, said protection unit receives transient spikes energy that exist at a regulated DC voltage, converts said energy, and sends this converted energy during a steady state to a switching stage.

5. A method according to claim 4, wherein said transfer of energy from the regulation stage to the switching stage is carried out in a current fed mode.

6. A method according to claim 4, wherein said protection unit accumulates energy from said transient spikes at a voltage fed mode, while said accumulated energy is transferred to the switching stage in a current fed mode.

7. A method according to claim 4, wherein said protection unit is located between said regulation stage and said switching stage.

8. A method according to claim 4, wherein said protection unit is connected in parallel between said regulation stage and said switching stage.

9. A method according to claim 4, wherein said protection unit comprises one or more switching elements and one or more accumulating elements.

10. A method according to claim 9, wherein said accumulating element is a capacitor.

11. A method according to claim 9, wherein said switching element determines a time of accumulating and a time of transfer of said energy.

12. A method according o claim 11, wherein said switching element is bidirectional.

13. A method according to claim 12, wherein said bidirectional switching element is an uncontrolled element or a controlled element.

14. A method according to claim 13, wherein the uncontrolled element is a diode and said controlled element is a transistor.
